(19) United States
(12) Patent Application Publication
(10) Pub. No.: US 2026/0095782 A1
(43) Pub. Date: Apr. 2, 2026

(54) CONFIGURING DYNAMIC TIME WINDOW FOR MANAGEMENT OPERATIONS IN A COMMUNICATION SYSTEM

(71) Applicant: RAKUTEN MOBILE, INC., Tokyo (JP)

(72) Inventors: Prasaanth GOWRAVALLI, Bangalore (IN); Yassar Sharaafath CHENNAMPILLIL AHAMADKUTTY, Bangalore (IN); Virendra REDDY, Bangalore (IN)

(73) Assignee: RAKUTEN MOBILE, INC., Tokyo (JP)

(21) Appl. No.: 19/082,282

(22) Filed: Mar. 18, 2025

(30) Foreign Application Priority Data
Sep. 30, 2024 (IN) 202441073650

(51) Int. Cl. H04W 24/02; H04L 41/08; H04L 41/0806

(52) U.S. Cl. CPC H04W 24/02; H04L 41/0806; H04L 41/0886

(57) ABSTRACT

The present disclosure relates to configuring dynamic time windows for performing management operations. In one embodiment, the present disclosure discloses a method which comprises configuring a dynamic time window for one or more management operations associated with one or more network elements. The method further comprises transmitting information related to the dynamic time window to the one or more network elements, instructing the one or more network elements to initiate the one or more management operations within the dynamic time window.

### CROSS REFERENCE TO RELATED APPLICATION(S)

This application claims priority based on India Patent Application No. 202441073650 filed Sep. 30, 2024, the entire disclosure of which is incorporated by reference herein.

### FIELD

The present disclosure relates to configuring a dynamic time window for management operations in a communication system.

### BACKGROUND

The information disclosed in this background section is only for enhancement of understanding of the general background of the disclosure and should not be taken as an acknowledgement or any form of suggestion that this information forms the prior art already known to a person skilled in the art.

Mobile telecommunications industry is experiencing tremendous growth in recent decades, driven by ever-increasing demand for connectivity and data services. To cater the ever-increasing demand of connectivity and data services, the technology is being constantly advanced and the advances in the technology have resulted in rapid growth in the field of wireless communication technology. The latest advancement in wireless communication technology is the development of next generation wireless communication systems (e.g., 4^{th}, 5^{th}, or 6^{th} Generation wireless communication systems).

In a typical wireless communication system, a user equipment (UE) may be provided communication services using a Radio Access Network (RAN) and a Core Network (CN). The RAN may comprise at least one base station. In a disaggregated architecture, the base station may be partitioned into different network elements. Likewise, the CN may also comprise one or more network elements. Each network element plays a critical role in operation of the wireless communication system.

To ensure the continuous and efficient operation of the network elements, a variety of management operations are needed. The management operations serve as essential maintenance tasks that keep the wireless communication system running smoothly. In other words, management operations may refer to the routine or reactive tasks performed on the network elements to address specific error scenarios without causing extended outages and for continuous working of the network elements. The management operations may include Periodic Certificate Renewal, system restart (e.g., restarting of Application, pod, device, etc.). In traditional solutions, the management operations i.e., whether certificate renewal or system restart are often executed in a reactive or manual manner.

In other words, in current communication systems, the management operations are often triggered in an ad-hoc manner. This means the management operations occur only when a certain condition/event is detected or when an administrator manually triggers them. Such event-driven triggering of the management operations means that no action is taken until something goes wrong, leaving the communication system vulnerable to sudden failures and unplanned outages. The outages may occur during the periods of high traffic (e.g., when many users are actively using the network), resulting in sudden loss of connectivity and downtime, which negatively affects user experience.

Likewise, in the manual approach, the network administrators may need to manually trigger the management operations upon observing a problem or receiving alerts about network issues. Such reliance on manual intervention may introduce delays, leading to further deterioration of network performance. Therefore, there is a need for further enhancements in scheduling management operations.

### SUMMARY

The present disclosure discloses techniques of configuring dynamic time windows for performing management operations within a communications system.

In one non-limiting embodiment, the present disclosure discloses a method which comprises, configuring a dynamic time window for one or more management operations associated with one or more network elements; and transmitting information related to the dynamic time window to the one or more network elements, instructing the one or more network elements to initiate the one or more management operations within the dynamic time window.

In one non-limiting embodiment, the present disclosure discloses an apparatus which is adapted to configure a dynamic time window for one or more management operations associated with one or more network elements; and transmit information related to the dynamic time window to the one or more network elements, instructing the one or more network elements to initiate the one or more management operations within the dynamic time window.

In one non-limiting embodiment, the present disclosure discloses a non-transitory computer readable media storing one or more computer executable instructions which, when executed by an apparatus, cause the apparatus to configure a dynamic time window for one or more management operations associated with one or more network elements; and transmit information related to the dynamic time window to the one or more network elements, instructing the one or more network elements to initiate the one or more management operations within the dynamic time window.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates a high-level block diagram illustrating a disaggregated architecture of an example communication system 100 (e.g., a 5G wireless communication system).

FIG. 2 illustrates a sequence diagram 200 illustrating communication between two entities to configure a dynamic time window for performing management operations, in accordance with some embodiments of the present disclosure.

FIG. 3 illustrates a block diagram of an apparatus 300, in accordance with some embodiments of the present disclosure.

FIG. 4 illustrates a flowchart illustrating an example method 400 for configuring a dynamic time window for one or more management operations associated with one or more network elements, in accordance with some embodiments of the present disclosure.

### DETAILED DESCRIPTION

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein may be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

The foregoing disclosure provides illustration and description but is not intended to be exhaustive or to limit the implementations to the precise form disclosed. Modifications and variations are possible in light of the above disclosure or may be acquired from practice of the implementations.

In the present disclosure, the terms like “communication system”, “system”, and “wireless communication system” have been used interchangeably throughout the specification. The terms like “CU-CP” and “CU-CP entity” may be used interchangeably throughout the description. The terms like “CU-UP” and “CU-UP entity” may be used interchangeably throughout the description.

In the context of present disclosure, a network element may refer to any network entity which performs a specific task in a communication system. The network element may be a logical or virtualized network element or a physical network element. In one example, the term “logical network entity” or “logical network element” includes both logical and physical network entities of RAN (e.g., Baseband Unit (BBU), CU, DU, RU, CU-CP, CU-UP, etc.) and network functions of CN (e.g., AMF, UPF, SMF, etc.). However, the present disclosure is not limited thereto and in general the term “network element” may refer to any network entity of the communication system.

In the context of present disclosure, the term “management operation” may refer to any routine or reactive task (or a series of tasks) performed by a network element for smooth running of different functions (both hardware and software) within the communication system. The management operations involve monitoring, controlling, and optimizing network resources and services so that the network functions run smoothly and continuously. The management operations may comprise one or more of: certificate renewal, fault management, application reset, application restart, software and firmware updates, configuration management, resource management, performance monitoring, data and storage management, energy management, but not limited thereto.

The “certificate renewal” operation may refer to updating of security certificates used for encryption and authentication in network communications. Various security protocols such as Transport Layer Security (TLS) and Secure Shell (SSH) use digital certificates to establish secure, encrypted connections between different components of a network. These certificates have expiration dates and need to be renewed to maintain secure communication. Failure to renew the certificates in a timely manner may expose the network to security risks. The “Fault Management” operation may refer to detecting, isolating, and correcting issues or malfunctions (such as hardware failures, software bugs, etc.) in the network elements. When an error or fault occurs, the fault management operation is triggered to identify and resolve the error or fault by initiating a failover mechanism.

The “Application Reset” operation may comprise reinitializing or resetting an application (which may be associated with a network element) behaving incorrectly to resolve issues causing the application to behave incorrectly. Application resetting may involve restoring the application to a stable state without affecting other operations within the communication system. The Application Reset operation may also comprise reinitializing or resetting a network element behaving incorrectly. Likewise, the “Application Restart” operation may comprise stopping a faulty application or network element and restarting it without affecting other operations within the communication system.

The “Software and Firmware Updates” operations may comprise applying new versions of applications or network elements. Such updates are essential to fix security vulnerabilities, fix bugs, improve performance, and introduce new features. The “Configuration Management” operation may comprise managing configurations of applications and/or network elements. The configuration management facilitates proper configuration and functioning of various and/or network elements of the communication system. The “Resource Management” operation may comprise allocating, monitoring, and optimizing network resources (such as processing resources, memory, bandwidth, etc.) used by the network elements to handle network traffic load and to avoid overloading or under-utilizing of network resources.

The “Performance monitoring” operation may comprise continuously measuring the performance (such as latency, throughput, etc.) of network elements. The “Data and storage management” operation may refer to efficiently handling data used by the network elements. The “Energy Management” operation may comprise optimizing power consumption across network elements while minimizing the carbon footprint.

It may be noted that the above-mentioned operations are just few examples of the management operations, and the techniques of the present disclosure are equally applicable for any type of management operation.

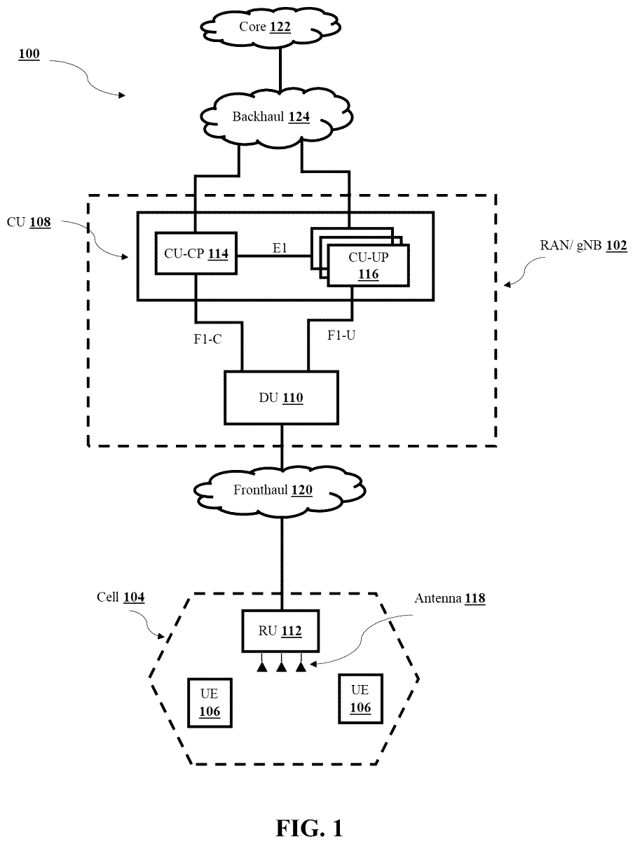

FIG. 1 shows a block diagram illustrating disaggregated architecture of an example communication system 100 comprising a Radio Access Network (RAN) or a base station 102 configured to serve a geographical area or cell 104. The cell 104 may comprise at least one UE 106 and the base station 102 may be configured to provide wireless services to the at least one UE 106 served by the associated cell 104. The at least one UE 106 may be any mobile or non-mobile computing device including, but not limited to, a phone (e.g., a cellular phone or smart phone), a pager, a laptop computer, a desktop computer, a wireless handset, a portable communication device, a portable computing device (e.g., a personal data assistant), an entertainment device (e.g., a music or video device, or a satellite radio), a global positioning system device, or any other suitable computing device including a wired or wireless communications interface. In some embodiments of the present disclosure, the at least one UE 106 may be Internet-of-Things (IoT)-enabled device including, but not limited to, vehicles configured to communicate with the base station or a core network. In the present disclosure, the terms RAN and base station have been used interchangeably.

In the context of a Fourth generation (4G) Long Term Evolution (LTE) technology, the base station 102 may also be referred to as an “evolved NodeB”, “eNodeB”, or “eNB” and, in the context of a fifth generation (5G) New Radio (NR) technology, the base station 102 may also be referred to as a “gNodeB” or “gNB”. It may be noted that the techniques of the present disclosure are explained in the context of 5^{th} generation communication technology, where the wireless communication system 100 is a 5G wireless communication system. However, the present disclosure is not limited thereto, and the techniques of the present disclosure are equally applicable for a variety of communication systems and/or technologies including, but not limited to, 4G wireless communication systems, 5G wireless communication systems, 6G wireless communication systems, etc.

In the exemplary embodiment of FIG. 1, the wireless communication system 100 may be implemented using a centralized or cloud RAN (C-RAN) disaggregated architecture in which the base station 102 is implemented as a 5G NR gNB 102 and may be partitioned into multiple logical network entities. For instance, the gNB 102 may be partitioned into a central unit (gNB-CU or CU) 108 and one or more distributed units (gNB-DUs or DUs) 110. In the embodiment of FIG. 1, the CU 108 may be further partitioned into a central unit control-plane entity 114 (gNB-CU-CP or CU-CP) and one or more central unit user-plane entities 116 (CU-UPs) that may handle the control-plane and user-plane processing of the CU 108, respectively. Such split enables the implementation of the CU-CP 114 and the CU-UP 116 entities in different locations.

The gNB 102 may comprise one or more physical entities such as Radio Units (RUs) 112 including one or more antennas 118 for serving the at least one UE 106 in the associated cell. The CU 108 may be communicatively coupled with the one or more DUs 110 via an F1 interface. The DU 110 is communicatively coupled with at least one RU 112 via a fronthaul interface 120. The CU-CP 114 is communicatively coupled with each of the CU-UPs 116 via an E1 interface and if further coupled with each of the DUs 110 via an F1-C interface. Each of the DUs 110 may be communicatively coupled to each of the CU-UPs 116 via an F1-U interface, as shown in FIG. 1.

In one non-limiting embodiment, each DU 110 may host multiple cells. The CU-CP 114 may host one or more DUs 110 and one or more CU-UPs 116. In one example deployment, there may be only one CU-CP 114 in a gNB 102, and each DU 110 may be served by multiple CU-UPs 116. The CU-CP 114 is responsible for managing control plane protocols and procedures. For instance, the CU-CP 114 may host Packet Data Convergence Protocol Control Plane (PDCP-C) layer and Radio Resource Control (RRC) layer, while the CU-UP 116 may host Packet Data Convergence Protocol-User Plane (PDCP-U) and Service Data Adaptation Protocol (SDAP) layers. The DU 110 may host lower layers such as Radio Link Control (RLC), Medium Access Control (MAC), and Physical (PHY) layers. The scheduling operation, which involves allocating radio resources to various UEs based on their requirements, current network conditions, and traffic demands, takes place at the DU 110.

The CU 108 may be configured to communicate with a core network 122 using a backhaul network 124. In one non-limiting embodiment of the present disclosure, the core network 122 may be a 5G core network which may utilize cloud-aligned, service-based architecture that spans across all 5G functions and interactions including authentication, security, session management etc.

In the exemplary embodiment of FIG. 1, the wireless communication system 100 may be implemented using the C-RAN architecture. However, the present disclosure is not limited thereto and in some deployments, the wireless communication system 100 may be implemented in accordance with any already known or future developed standard and specification. For example, the RAN communication system 100 may be implemented using an architecture defined by the Open Radio Access Network (O-RAN) Alliance.

As discussed earlier, each network element requires one or more management operations to ensure smooth, continuous, and efficient operation. In current implementations, the management operations are often triggered in a reactive manner i.e., the management operations occur in an ad-hoc manner or only in response to specific conditions or events that indicate a problem or the need for maintenance. For example, the certificate renewal management operation is initiated when a certificate is about to expire or has already expired, the fault management operation is started when an error is detected, the resource allocation/reallocation operation occurs when there is high congestion or performance degradation in the communication system.

In such scenarios, the management operations are triggered in a reactive manner (i.e., the management operations occur after a problem or condition arises), resulting in unplanned outages or downtime. For instance, if a critical network element requires a restart or update during peak usage hours, it may cause service interruptions, leading to poor user experience and potential network downtime. Specifically, when outages or performance issues arise due to unplanned management actions, customers may experience slow speeds, connection drops, and reduced service quality. The ad-hoc management operations also have a higher risk of human error (e.g., when manual intervention is required). For example, an administrator might accidentally restart a wrong network element, or there could be delays in responding to urgent issues.

In order to overcome the above-mentioned and other related challenges, the present disclosure discloses a proactive and controlled approach for executing/triggering management operations. In the present disclosure, instead of triggering the management operations in an ad-hoc or reactive manner, the management operations are pre-scheduled based on one or more factors. In other words, a dynamic time window for performing the one or more management operations may be configured/set based on the one or more factors. Specifically, the management operations can be scheduled at times that best suit the flexibility of operator and network load. Operators can select optimal time windows for management operations (or maintenance activities) to ensure that the management operations do not disrupt critical operations of the communication system, thereby reducing the risk of downtime or unplanned outages. For example, the application restart, application reset, software update related management operations may be planned during periods of minimal network activity (e.g., late at night or early morning) to avoid disruptions to high-traffic services such as video streaming, gaming, or business-critical applications.

The one or more factors may include network traffic patterns (management operations are typically scheduled during off-peak hours), real-time network conditions (such as bandwidth usage, latency, network congestion, etc. are taken into account for determining when to schedule the management operations). The one or more factors may further include operator flexibility and priority (i.e., operators may have flexibility to choose suitable time windows based on their own priorities and user demands), service-level criticality (e.g., operations that affect critical applications may be avoided during working hours).

The one or more factors may further include a type of management operation (e.g., resource intensive operations may be scheduled during long and off-peak periods, while non-resource intensive operations may be scheduled even during peak hours with minimal disruption). In some instances, the one or more factors may also include geographical considerations (e.g., different regions may have different peak usage times due to time zone differences). In some instances, historical network performance data may be used to forecast when issues are most likely to arise, and the management operations may be accordingly scheduled. Some operators may consider energy efficiency and energy utilization while scheduling the management operations. The present disclosure is not limited to the above-specified factors and in general, the one or more factors may include other similar factors for executing the management operations in an optimal and minimally disruptive manner, thereby reducing the downtime/unplanned outages, improving service reliability, and enhancing user experience.

The forthcoming paragraphs now describe the techniques of configuring/setting a dynamic time window for performing the management operations so as to minimize the impact on network performance and service disruption.

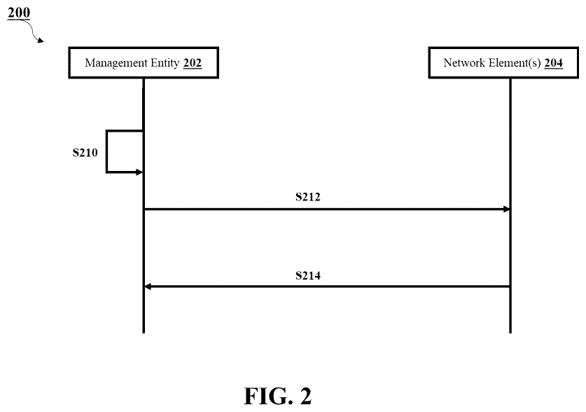

FIG. 2 illustrates a sequence diagram 200 illustrating communication between two entities to configure/set a dynamic time window for performing the management operations, in accordance with some embodiments of the present disclosure. Specifically, FIG. 2 shows a management entity 202 communicating with a network element 204 for configuring a dynamic time window for one or more management operations. As discussed above, the network element(s) may refer to any network entity which performs a specific task in the communication system 100. The management entity 202 may refer to any network entity configured to handle different management operations and network elements. In one example, the management entity may include Operations Support System (OSS), Element Management System (EMS), Network Management Systems (NMS), or any other similar entity. The management entity 202 may be a part of either the RAN or the CN, depending on the requirements (e.g., depending on where the network elements are located and what operations are to be scheduled).

In operation S210 of FIG. 2, the management entity 202 is adapted to set/configure/determine a dynamic schedule or a dynamic time for performing one or more management operations associated with one or more network elements 204. The dynamic time window represents an optimal period during which management operations can be executed without adversely affecting network performance or user experience. In operation S212 of FIG. 2, after configuring the dynamic time window, the management entity 202 is adapted to transmit or communicate information related to the dynamic time window to the one or more network elements 204. Specifically, management entity 202 instructs the one or more network elements 204 to initiate the one or more management operations within the configured dynamic time window.

It may be noted that the dynamic time window may be configured in a number of ways by taking into account the above-discussed one or more factors. In other words, the information related to the dynamic time window may be provided to the one or more network elements 204 in a number of ways. Initially, management entity 202 may set a start time and an end time for the dynamic time window, and may set a recurring interval for the dynamic time window.

In a first approach, the management entity 202 may generate a detailed network element level configuration for each of the one or more network elements and transmit the generated network element level configuration to the one or more network elements. In a second approach, the management entity 202 may transmit runtime triggers to the one or more network elements, the run time triggers comprising the information related to the dynamic time window.

In the first approach, the management entity 202 generates a detailed network element level configuration for each of the one or more network elements. This configuration contains specific details, such as the start time and the end time of the dynamic time window. These time values (i.e., the start time value and the end time value) can either be absolute time values or fixed time values (e.g., 2 AM daily) or relative time values (i.e., times set in reference to a specific event or condition e.g., 1 hour after an event occurs).

Specifically, the absolute time value is a fixed point on the clock, such as 2 AM. When using an absolute time value, the management entity 202 sets specific hours during which the management operations occur. For example, the management entity may schedule a management operation every day between 2 AM and 4 AM (e.g., when network traffic is low). The relative time value is based on an event or condition rather than the clock. The relative time value specifies when an operation should start or end relative to another event (such as an error or trigger). For example, the start time for an operation may be set as “1 hour after a network event occurs,” and the end time may be set as “2 hours after the operation begins.”

The management entity 202 can also facilitate setting a recurring interval or pattern for the dynamic time widow. For example, a management operation might need to happen daily, weekly, monthly, quarterly, and the like, depending on the nature of the management operations. The recurrence is set as daily when a management operation occurs every day at the same time, such as between 2 AM and 4 AM. The recurrence is set as weekly when the management operation happens on a specific day/time each week. For less frequent management operations, the recurrence interval may be scheduled once a month or even once every few months.

It may be noted that the values of the start time, end time, and recurring interval may be set/determined taking into account the above-discussed one or more factors. In one example, the management entity 202 may automatically determine the values of the start time, end time, and recurring interval associated with the dynamic time window. In another example, the values of the start time, end time, and recurring interval may be set manually (e.g., by taking into account the one or more factors).

Once the start time, end time, and/or the recurring pattern are set/defined, the management entity 202 may generate a network element level configuration for each of the one or more network elements 204. The network element level configuration may comprise the start and end times (i.e., specific time window during which the management operations should be performed) and the recurring interval of the dynamic time window (the frequency at which the management operations should be repeated).

After generating the network element level configuration, the management entity 202 may then push or transmit the generated network element level configuration to the one or more network elements (e.g., as a part of configuration block), thereby instructing the one or more network elements to initiate the one or more management operations within the dynamic time window. A configuration block comprises all the necessary instructions for the network element to execute the operations within the designated dynamic time window. Each network element and/or sub-component of the network element that requires management operations, subscribes to the configuration block (also referred to as the “nf-management-operations-window”). The sub-components may include applications, pods, devices, or other sub-systems that are part of a larger network infrastructure. By subscribing, the network elements/sub-components are aware of the dynamic time window and are instructed to perform necessary management operations within said dynamic time window. Once the dynamic time window begins, the subscribed network elements/sub-components perform necessary management operations.

In the second approach, the management entity 202 may utilize runtime triggers to configure or communicate the dynamic time window for performing the management operations related to the one or more network elements. The triggers may be communicated using various communication protocols or messaging systems such as Network Configuration Protocol-Remote Procedure Call (NETCONF RPC), gRPC, Kafka messages, but not limited thereto. The triggers provide real-time information about the dynamic time window in which the management operations are scheduled to occur. Such approach provides a flexible and on-demand way to handle management operations, thereby allowing real-time adjustments of the time window without transmitting configuration blocks every time.

In one implementation of the second approach, the management entity 202 may transmit a single trigger having all the necessary information about the dynamic time window. The information includes one or more of the start time, the end time, and the recurring interval. Here also, the start time and end times may have absolute time values or relative time values.

In another implementation of the second approach, the management entity 202 may transmit multiple triggers instead of sending all the information in a single runtime trigger. Specifically, the management entity 202 may transmit a start trigger indicating the start time of the dynamic time window. The start time may be absolute start time or relative start time. The start trigger may also include additional information about the end time (either absolute or relative). For instance, if the start time is an absolute value (e.g., “start at 2 AM”), the start trigger may also indicate a relative end time (e.g., “finish 2 hours after starting”). If the start trigger does not comprise information about when the operation should end, the management entity 202 may send a separate end trigger indicating the end time of the dynamic window. The end time may be an absolute end time (e.g., “end at 4 AM”) or a relative end time (e.g., “end 2 hours after the start”).

The start and/or the end triggers may additionally comprise information related to the recurring interval of the dynamic time window. In one example, when the start and/or the end triggers does not comprise the information related to the recurring interval of the dynamic time window, the information related to the recurring interval of the dynamic time window may be transmitted in a separate trigger.

Once the information related to the dynamic time window (e.g., start time, end time, and/or recurring interval) is received, the one or more network elements 204 may initiate the management operations within the defined dynamic time window. For example, a device may reboot, or a certificate may be renewed automatically during the specified time window. By using the set schedule, the management operations are performed at optimal times (e.g., during low traffic hours) and the risk of unplanned outages is minimized. Further, the recurring nature of the time window facilitates that the management operations are performed regularly.

Typically, the dynamic time window includes a start time and an end time, explicitly indicating when the management tasks should begin and when they should stop. However, there may be scenarios where the end time might not be explicitly indicated by the management entity. In such cases, the network element may set the duration of the management operations autonomously by applying preset criteria to determine when to stop for these tasks.

In one aspect, when information related to the end time is not explicitly provided to the network elements, the network elements are configured to stop the management operations at an appropriate time. The network elements rely on preset criteria defined during initial deployment phase. For example, if a management operation (like a software update) begins at 2 AM, and no explicit end time is provided to the associated network element, the network element may be configured to stop the operation after a standard time frame, such as 30 minutes or 1 hour, so that the operations are completed within a reasonable period.

The dynamic time window during which the management operations are performed, may be set up or configured in different phases of network lifecycle. In one example, the dynamic time window may be configured for the first time at the time of the initial deployment of the network elements. Specifically, during the initial deployment, the management entity 202 sets the time window for subsequent management operations. In another example, the time window may be configured (for the first time) after the initial deployment phase. For example, once the communication system is operational and stable, the management entity 202 may introduce a scheduled time window for performing the management operations.

In one example, regardless of when the dynamic time window is configured, the window may need adjustments as the communication system evolves. In such cases, the initial time window (e.g., set at the time of initial deployment-configuration phase or set after the initial deployment-configuration phase i.e., during ongoing-operations phase) may be updated based on one or more parameters. The one or more parameters may comprise change in network configuration (e.g., change of network applications and/or network elements), change in user requirements, for load balancing, and the like.

It may be noted that the dynamic time window is set/configured only for those network elements/applications which do not require immediate attention. The management entity 202 may distinguish between network elements or applications that can defer their management operations and those that require immediate attention. Such dynamic prioritization ensures that critical network elements are configured to perform management operations without delay, while non-critical elements may wait for the scheduled time window.

It may be noted that the management operations are scheduled carefully to reduce user impact and optimize overall network performance. In one approach (referred to as “network element-based scheduling”), the management operations may be scheduled based on types of network elements involved. In such approach, similar network elements may be configured to perform their management operations during the same time window. For example, all CUs may be configured to perform their management operations between 2 AM-4 AM (e.g., when network usage is low). Similarly, all DUs may have their own designated time window for management operations.

In another approach (referred to as “number of network element based scheduling”), instead of scheduling management operations for all network elements of the same type at once, a subset of network elements may be selected to perform the management operations during a given time window. For example, in a dense communication system with a large number of DUs, only 20% of the DUs may be configured to perform the management operations during 2 AM-4 AM time window, while another 20% may be scheduled for 4 AM-6 AM, and the like. Such staggered approach avoids downtime across the entire communication system.

In yet another approach (referred to as “application based scheduling”), the network applications/sub-components that perform similar functions, regardless of the network elements they belong to, may be grouped and configured to perform management operations during the same time window. This is especially useful in systems where applications run on multiple types of hardware, but require uniform management operations. For example, all applications which require certificate renewal may undergo the certificate renewal operation during the same time window, even if the applications are running on different types of network elements (e.g., CU, DU, or RU).

In yet another approach (referred to as “management operation specific scheduling”), all management operations of a similar type may be performed during the same time window, regardless of the type of network elements or applications involved. For example, if a software update is required for multiple applications across multiple network elements, the management entity may schedule the software update operation for the same time window, irrespective of network elements or applications involved. It may be noted that the present disclosure is not limited to the above-discussed scheduling approaches only, and in general different types and permutations of the scheduling approaches are possible.

In one example, the management entity 202 is configured to dynamically update the time window based on one or more real-time factors. For example, if the communication system is facing higher-than-expected traffic, the management entity 202 may dynamically adjust the time window to postpone the maintenance operations. The one or more factors used for determining the dynamic time window may also be used for updating the dynamic time window.

In operation S212 of FIG. 2, the network elements or the applications may proactively request the management entity 202 to update or configure the dynamic time window. The network elements or applications monitor their own performance parameters. If they detect a situation where a management operation (such as a system restart, software update, or certificate renewal) need to be scheduled or rescheduled, it can send a request to the management entity to either update an existing time window or configure a new time window.

In this manner, the techniques of the present disclosure configure/set the dynamic time window, and the network elements and/or application wait for their designated time windows before initiating management operations. By performing the management operations during planned time windows, the impact on user experience may be minimized and unexpected network failures or service outages may be avoided. Further, by distributing management operations across different time windows, the techniques of the present disclosure balance load on the network infrastructure, thereby preventing performance degradation and improving overall stability and reliability of the network. Further, pre-scheduling of the management operations eliminate the need for manual intervention and reactive maintenance.

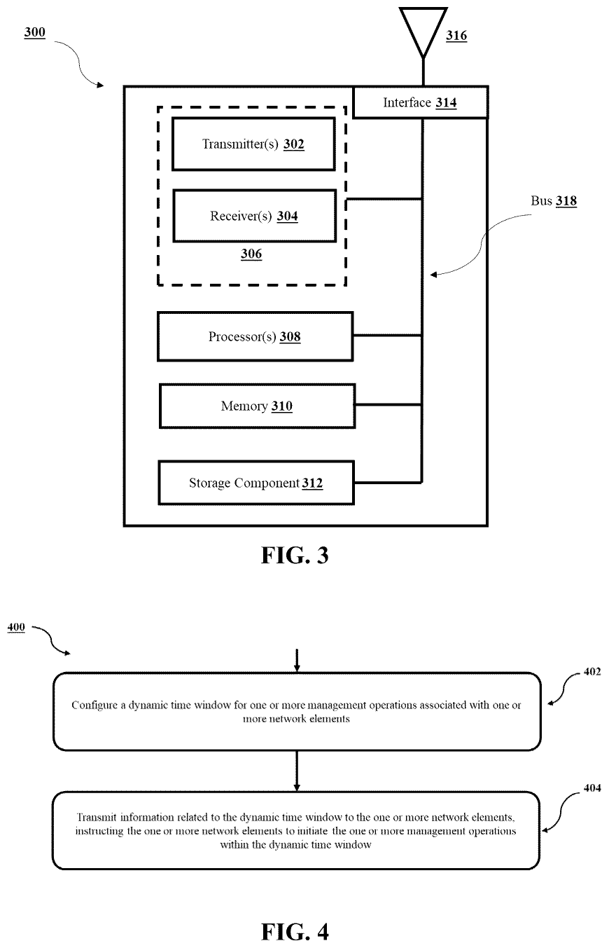

FIG. 3 illustrates a block diagram of an apparatus 300, in accordance with some embodiments of the present disclosure. As shown in FIG. 3, the apparatus 300 may comprise at least one transmitter or output component 302, at least one receiver or input component 304, at least one processor 308, at least one memory 310, at least one storage component 312, at least one interface 314, and at least one antenna 316. The at least one transmitter 302 may be configured to transmit data/information to one or more external nodes/devices using the antenna 316 and the at least one receiver 304 may be configured to receive data/information from the one or more external nodes/devices using the antenna 316. The at least one transmitter and receiver may be collectively implemented as a single transceiver or input-output module 306. In one non-limiting embodiment, the at least one processor 308 may be communicatively coupled with the transceiver 306, the memory 310, the storage component 312, the interface 314, and the antenna 316 (e.g., via a bus 318) for implementing the techniques consistent with the present disclosure. The bus 318 may include a wired interconnection or a wireless interconnection.

The at least one processor 308, as used herein, means any type of computational circuit that may comprise hardware elements and software elements. The processor 308 may be embodied as a multi-core processor, a single core processor, or a combination of one or more multi-core processors and/or one or more single core processors, a distributed processing system, or the like. The processor 308 may be a Central Processing Unit (CPU), a graphics processing unit (GPU), an accelerated processing unit (APU), an application-specific integrated circuit (ASIC), or another type of processing component.

The memory 310 may include a non-transitory computer readable medium. The memory 310 may include a random-access memory (RAM), a read only memory (ROM), and/or another type of dynamic or static storage device (e.g., a flash memory, a magnetic memory, and/or an optical memory) that stores information and/or instructions for use by processor 308. The memory 310 may comprise machine-readable instructions which are executable by the processor 308. These machine-readable instructions when executed by the processor 308 cause the processor 308 to perform one or more method steps of an embodiment described above.

The apparatus 300 may include the storage component 312 which stores information and/or software related to the operation and use of the apparatus 300. For example, the storage component 312 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

The communication interface 314 is an interface that provides a communication connection to other devices, such as external devices and internal devices. The connection by the communication interface 314 can be a wired connection, a wireless connection, or a combination of wired and wireless connections, and can be a direct connection or an indirect connection via a communication network that exists between the apparatus 300 and other devices. In other words, the standard of the communication interface 314 is not limited.

The bus 318 acts as an interconnect between the processor 308, the memory 310, the storage component 312, the transmitter 302, the receiver 304, the communication interface 314, and the antenna 316 of the apparatus 300.

The number and arrangement of components shown in FIG. 3 are provided as an example. In practice, the apparatus 300 may include additional components, fewer components, different components, or differently arranged components than those shown in FIG. 5. Additionally, or alternatively, a set of components (e.g., one or more components) of the apparatus 300 may perform one or more functions described as being performed by another set of components of the apparatus 300. Further, one or more method steps described in any of the embodiments may be performed utilizing a plurality of apparatuses 300 in communication with one another.

In one non-limiting embodiment, the apparatus 300 may be used to implement some or all functions of any entity including UEs, various network entities of the RAN, various entities of the core network, but not limited thereto. Specifically, the apparatus 300 may implement the functionalities of the management entity 202.

Referring now to FIG. 4, a flowchart is described illustrating an example method 400 performed by a management entity 202 for configuring a dynamic time window for one or more management operations associated with one or more network elements, according to an embodiment of the present disclosure. The network elements may include any network entity of the RAN 102 (i.e., the CU 108, the DU 110, the CU-CP 114, and the CU-UP 116) or any network function of the CN 122. The operations of the management entity 202 may be implemented with the help of the apparatus 300 (and particularly, with the help of the at least one processor 308).

The method 400 may include, at block 402, configuring a dynamic time window for performing one or more management operations associated with one or more network elements 204. At block 404, the method 400 may include transmitting information related to the dynamic time window to the one or more network elements 204, instructing the one or more network elements 204 to initiate the one or more management operations within the dynamic time window.

### Embodiments

Embodiment 1. A method comprising: configuring a dynamic time window for one or more management operations associated with one or more network elements; and transmitting information related to the dynamic time window to the one or more network elements, instructing the one or more network elements to initiate the one or more management operations within the dynamic time window.

Embodiment 2: The method of embodiment 1, wherein configuring the dynamic time window for the one or more management operations comprises: setting a start time and an end time for the dynamic time window, wherein the start time and the end time represent absolute time values or relative time values; and setting a recurring interval for the dynamic time window.

Embodiment 3: The method of embodiment 2, further comprising: generating a network element level configuration for the one or more network elements, wherein the network element level configuration comprises the start time, the end time, and the recurring interval of the dynamic time window; and transmitting the generated network element level configuration to the one or more network elements, instructing the one or more network elements to initiate the one or more management operations within the dynamic time window.

Embodiment 4: The method of embodiment 2, further comprising transmitting at least one runtime trigger to the one or more network elements, wherein the at least one runtime trigger comprises the start time, the end time, and the recurring interval of the dynamic time window.

Embodiment 5: The method of embodiment 2 or 4, further comprising: transmitting a start trigger indicating the start time of the dynamic time window, wherein the start trigger comprises additional information related to the absolute or relative end times of the dynamic time window; and transmitting an end trigger indicating the absolute or relative end time of the dynamic time window.

Embodiment 6: The method of any of the embodiments 1-5, further comprising updating, based on one or more parameters, the dynamic time window after initial deployment-configuration phase or during ongoing-operations phase.

Embodiment 7: The method of any of the embodiments 1-6, wherein the one or more network elements are part of a communication system comprising a Radio Access Network (RAN) communicatively connected to a Core Network (CN), and wherein the one or more network elements comprise one or more of following: at least one Radio Unit (RU), at least one Central Unit (CU), at least one Distributed Unit (DU), at least one Central Unit-User Plane (CU-UP) entity, at least one Central Unit-Control Plane (CU-CP) entity, and at least one Network Function (NF) within the CN.

Embodiment 8: The method of any of the embodiments 1-7, wherein the one or more management operations comprise one or more of: certificate renewal, fault management, application reset, application restart, software and firmware updates, configuration management, resource management, performance monitoring, data and storage management, energy management.

Embodiment 9: An apparatus adapted to: configure a dynamic time window for one or more management operations associated with one or more network elements; and transmit information related to the dynamic time window to the one or more network elements, instructing the one or more network elements to initiate the one or more management operations within the dynamic time window.

Embodiment 10: The apparatus of embodiment 9, wherein to configure the dynamic time window for the one or more management operations, the apparatus is adapted to: set a start time and an end time for the dynamic time window, wherein the start time and the end time represent absolute time values or relative time values; and set a recurring interval for the dynamic time window.

Embodiment 11: The apparatus of embodiment 10, further configured to: generate a network element level configuration for the one or more network elements, wherein the network element level configuration comprises the start time, the end time, and the recurring interval of the dynamic time window; and transmit the generated network element level configuration to the one or more network elements, instructing the one or more network elements to initiate the one or more management operations within the dynamic time window.

Embodiment 12: The apparatus of embodiment 10, further configured to: transmit at least one runtime trigger to the one or more network elements, wherein the at least one runtime trigger comprises the start time, the end time, and the recurring interval of the dynamic time window.

Embodiment 13: The apparatus of embodiment 10 or 12, further configured to: transmit a start trigger indicating the start time of the dynamic time window, wherein the start trigger comprises additional information related to the absolute or relative end times of the dynamic time window; and transmit an end trigger indicating the absolute or relative end time of the dynamic time window.

Embodiment 14: The apparatus of any of embodiments 9-13, wherein the apparatus is adapted to update, based on one or more parameters, the dynamic time window after initial deployment-configuration phase or during ongoing-operations phase.

Embodiment 15: The apparatus of any of embodiments 9-14, wherein the one or more network elements are part of a communication system comprising a Radio Access Network (RAN) communicatively connected to a Core Network (CN), and wherein the one or more network elements comprise one or more of following: at least one Radio Unit (RU), at least one Central Unit (CU), at least one Distributed Unit (DU), at least one Central Unit-User Plane (CU-UP) entity, at least one Central Unit-Control Plane (CU-CP) entity, and at least one Network Function (NF) within the CN.

Embodiment 16: The apparatus of any of embodiments 9-15, wherein the one or more management operations comprise one or more of: certificate renewal, fault management, application reset, application restart, software and firmware updates, configuration management, resource management, performance monitoring, data and storage management, energy management.

Embodiment 17: A non-transitory computer readable media storing one or more computer executable instructions which, when executed by an apparatus, cause the apparatus to: configure a dynamic time window for one or more management operations associated with one or more network elements; and transmit information related to the dynamic time window to the one or more network elements, instructing the one or more network elements to initiate the one or more management operations within the dynamic time window.

Embodiment 18: The non-transitory computer readable media of embodiment 17, wherein to configure the dynamic time window for the one or more management operations, the one or more instructions cause the apparatus to: set a start time and an end time for the dynamic time window, wherein the start time and the end time represent absolute time values or relative time values; and set a recurring interval for the dynamic time window.

Embodiment 19: The non-transitory computer readable media of embodiment 18, wherein the one or more instructions further cause the apparatus to: generate a network element level configuration for the one or more network elements, wherein the network element level configuration comprises the start time, the end time, and the recurring interval of the dynamic time window; and transmit the generated network element level configuration to the one or more network elements, instructing the one or more network elements to initiate the one or more management operations within the dynamic time window.

Embodiment 20: The non-transitory computer readable media of embodiment 18, wherein the one or more instructions further cause the apparatus to: transmit at least one runtime trigger to the one or more network elements, wherein the at least one runtime trigger comprises the start time, the end time, and the recurring interval of the dynamic time window.

In a non-limiting embodiment of the present disclosure, one or more non-transitory computer-readable media may be utilized for implementing the embodiments consistent with the present disclosure. A computer-readable media refers to any type of physical memory (such as the memory 310) on which information or data readable by a processor may be stored. Thus, a computer-readable media may store one or more instructions for execution by the apparatus or by the at least one processor 308, including instructions for causing the at least one processor 308 to perform steps or stages consistent with the embodiments described herein. Certain non-limiting embodiments may comprise a computer program product for performing the operations presented herein. For example, such a computer program product may comprise a computer readable media having instructions stored (and/or encoded) thereon, the instructions being executable by one or more processors to perform the operations described herein.

It may be noted here that the subject matter of some or all embodiments described with reference to FIGS. 1-3 may be relevant for the method 400 and the same is not repeated for the sake of brevity. The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the embodiments of the present disclosure are intended to be illustrative, but not limiting, of the scope of the disclosure, which is set forth in the appended claims.

We claim:

1. A method comprising:
configuring a dynamic time window for one or more management operations associated with one or more network elements; and
transmitting information related to the dynamic time window to the one or more network elements, instructing the one or more network elements to initiate the one or more management operations within the dynamic time window.

2. The method as claimed in claim 1, wherein configuring the dynamic time window for the one or more management operations comprises:
setting a start time and an end time for the dynamic time window, wherein the start time and the end time represent absolute time values or relative time values; and
setting a recurring interval for the dynamic time window.

3. The method as claimed in claim 2, further comprising:
generating a network element level configuration for the one or more network elements, wherein the network element level configuration comprises the start time, the end time, and the recurring interval of the dynamic time window; and
transmitting the generated network element level configuration to the one or more network elements, instructing the one or more network elements to initiate the one or more management operations within the dynamic time window.

4. The method as claimed in claim 2, further comprising transmitting at least one runtime trigger to the one or more network elements, wherein the at least one runtime trigger comprises the start time, the end time, and the recurring interval of the dynamic time window.

5. The method as claimed in claim 2, further comprising:
transmitting a start trigger indicating the start time of the dynamic time window, wherein the start trigger comprises additional information related to the absolute or relative end times of the dynamic time window; and
transmitting an end trigger indicating the absolute or relative end time of the dynamic time window.

6. The method as claimed in claim 1, further comprising updating, based on one or more parameters, the dynamic time window after initial deployment-configuration phase or during ongoing-operations phase.

7. The method as claimed in claim 1, wherein the one or more network elements are part of a communication system comprising a Radio Access Network (RAN) communicatively connected to a Core Network (CN), and wherein the one or more network elements comprise one or more of following:
at least one Radio Unit (RU), at least one Central Unit (CU), at least one Distributed Unit (DU), at least one Central Unit-User Plane (CU-UP) entity, at least one Central Unit-Control Plane (CU-CP) entity, and at least one Network Function (NF) within the CN.

8. The method as claimed in claim 1, wherein the one or more management operations comprise one or more of: certificate renewal, fault management, application reset, application restart, software and firmware updates, configuration management, resource management, performance monitoring, data and storage management, energy management.

9. An apparatus adapted to:
configure a dynamic time window for one or more management operations associated with one or more network elements; and
transmit information related to the dynamic time window to the one or more network elements, instructing the one or more network elements to initiate the one or more management operations within the dynamic time window.

10. The apparatus as claimed in claim 9, wherein to configure the dynamic time window for the one or more management operations, the apparatus is adapted to:
set a start time and an end time for the dynamic time window, wherein the start time and the end time represent absolute time values or relative time values; and
set a recurring interval for the dynamic time window.

11. The apparatus as claimed in claim 10, further adapted to:
generate a network element level configuration for the one or more network elements, wherein the network element level configuration comprises the start time, the end time, and the recurring interval of the dynamic time window; and
transmit the generated network element level configuration to the one or more network elements, instructing the one or more network elements to initiate the one or more management operations within the dynamic time window.

12. The apparatus as claimed in claim 10, further adapted to:
transmit at least one runtime trigger to the one or more network elements, wherein the at least one runtime trigger comprises the start time, the end time, and the recurring interval of the dynamic time window.

13. The apparatus as claimed in claim 10, further adapted to:
transmit a start trigger indicating the start time of the dynamic time window, wherein the start trigger comprises additional information related to the absolute or relative end times of the dynamic time window; and
transmit an end trigger indicating the absolute or relative end time of the dynamic time window.

14. The apparatus as claimed in claim 9, further adapted to:
update, based on one or more parameters, the dynamic time window after initial deployment-configuration phase or during ongoing-operations phase.

15. The apparatus as claimed in claim 9, wherein the one or more network elements are part of a communication system comprising a Radio Access Network (RAN) communicatively connected to a Core Network (CN), and wherein the one or more network elements comprise one or more of following:
at least one Radio Unit (RU), at least one Central Unit (CU), at least one Distributed Unit (DU), at least one Central Unit-User Plane (CU-UP) entity, at least one Central Unit-Control Plane (CU-CP) entity, and at least one Network Function (NF) within the CN.

16. The apparatus as claimed in claim 9, wherein the one or more management operations comprise one or more of: certificate renewal, fault management, application reset, application restart, software and firmware updates, configuration management, resource management, performance monitoring, data and storage management, energy management.

17. A non-transitory computer readable media storing one or more computer executable instructions which, when executed by an apparatus, cause the apparatus to:
configure a dynamic time window for one or more management operations associated with one or more network elements; and
transmit information related to the dynamic time window to the one or more network elements, instructing the one or more network elements to initiate the one or more management operations within the dynamic time window.

18. The non-transitory computer readable media as claimed in claim 17, wherein to configure the dynamic time window for the one or more management operations, the one or more instructions cause the apparatus to:
set a start time and an end time for the dynamic time window, wherein the start time and the end time represent absolute time values or relative time values; and
set a recurring interval for the dynamic time window.

19. The non-transitory computer readable media as claimed in claim 18, wherein the one or more instructions further cause the apparatus to:
generate a network element level configuration for the one or more network elements, wherein the network element level configuration comprises the start time, the end time, and the recurring interval of the dynamic time window; and
transmit the generated network element level configuration to the one or more network elements, instructing the one or more network elements to initiate the one or more management operations within the dynamic time window.

20. The non-transitory computer readable media as claimed in claim 18, wherein the one or more instructions further cause the apparatus to:
transmit at least one runtime trigger to the one or more network elements, wherein the at least one runtime trigger comprises the start time, the end time, and the recurring interval of the dynamic time window.
